(19) United States
(12) Patent Application Publication
(10) Pub. No.: US 2003/0112919 A1
(43) Pub. Date: Jun. 19, 2003

(54) Nuclear reactor of the pebble bed type

(76) Inventor: Mark Andrew Davies, Centurion (ZA)

Correspondence Address: CARTER WHITE, HOWREY SIMON ARNOLD AND WHITE LLP, 750 BERING DRIVE, HOUSTON, TX, 77057, US

(21) Appl. No.: 10/311,908

(22) PCT Filed: Jun. 21, 2001
(86) PCT No.: PCT/IB01/01090

(30) Foreign Application Priority Data
Jun. 29, 2000 (ZA) 00/3277

(51) Int. Cl. G21C 15/00

(52) U.S. Cl. 376/381

(57) ABSTRACT

The invention provides a method of handling fuel spheres in a nuclear reactor which includes scanning the spheres using a tomography scanner to permit identification of the fuel spheres. The invention extends to a nuclear plant having scanners at different positions to identify and control the movement of the fuel spheres. The invention further extends to a fuel element which incorporates particles intended specifically to facilitate identification of the fuel element.

THIS INVENTION relates to a nuclear reactor. More particularly, the invention relates to a nuclear plant having a nuclear reactor of the pebble bed type incorporating means for handling fuel elements of the reactor. The invention extends to a method of handling such fuel elements and to a fuel element.

In a nuclear reactor of the high temperature gas cooled type, a fuel comprising a plurality of spherical fuel elements is used. The fuel elements may comprise spheres of a fissionable material in a ceramic matrix, or encapsulated in a ceramic material. The reactor may be helium cooled. The fuel spheres are known as pebbles and a reactor of this type is generally know as a pebble bed (PB) reactor. In a PB reactor it is known to operate a multi-pass fuelling scheme in which fuel spheres are passed through a core of the reactor more than once in order to optimise burn-up of fuel. In comparison with other fuelling schemes, a multi-pass fuelling scheme is believed to provide for a more uniform distribution of burn-up within the core and thereby flattens the axial neutron flux profile and maximises thermal power output of the reactor core. In this specification, a reactor as described above will be referred to interchangeably as a pebble bed (PB) reactor or a nuclear reactor of the pebble bed type.

In one embodiment of a reactor of the pebble bed type, each of the fuel spheres is approximately 60 mm in diameter and contains approximately 15000 coated fuel particles. The fuel particles are generally uniformly distributed throughout an inner spherical volume of about 50 mm in diameter, surrounding which is a 5 mm layer of graphite. In a typical reactor, each such fuel sphere may contain approximately 9 g of uranium, i.e. each fuel particle contains about 0.6 μg of uranium. The coated particles are TRISO particles, i.e. triple coated UO₂ particles, with a UO₂ kernel of 0.5 mm diameter and a density of approximately 10.5 g/cm³ and afuel enrichment of about 8%. It will be appreciated that the number of fuel particles within a fuel sphere, the fuel enrichment and the amount of heavy metal may be varied and may be adjusted to achieve desired power outputs and peak fuel temperatures. Each fuel kernel has four coatings applied thereto being, from inner to outer layer: a layer of buffer carbon, a pyrolytic carbon layer, a silicon carbide layer and a second layer of pyrocarbon. Typically examples of the thicknesses and densities of these layers are set out hereunder:

| Layer | Buffer C | Inner Pyro C | SiC | Outer Pyro C |
|---|---|---|---|---|
| Thickness mm | 0.095 | 0.040 | 0.035 | 0.040 |
| Density g/cm³ | 1.05 | 1.90 | 3.17 | 1.90 |

The density of the graphite matrix, being a mixture of natural and synthetic graphites, surrounding the coated particles is approximately 1.75 g/cm³. Thus, the total mass of a fuel sphere is approximately 210 gm.

In a small modular pebble bed reactor there may be at least about 300000 fuel spheres in the reactor system, while the reactor is in operation.

It will be appreciated that in any nuclear reactor, reactor safety and reactor performance are of primary concern and require continual monitoring. In a PB reactor, it is important to monitor each fuel sphere for compliance with predetermined specifications, before permitting loading of the said sphere into the reactor core.

According to one aspect of the invention there is provided a method of handling fuel spheres suitable for use in a pebble bed reactor which includes the step of scanning each fuel sphere at least once to provide a representation thereof.

The method may include recording the representation of the fuel sphere.

The representation may be a two-dimensional image. The two-dimensional image may be a sectional slice through the fuel sphere. In a preferred embodiment of the invention, the representation is a three-dimensional image.

The method may include scanning the fuel sphere with X-rays by means of a CT (computerised tomography) scanner and producing a digital image of the fuel sphere.

In a preferred embodiment of the invention, the image is a digital three-dimensional computer reconstruction of the fuel sphere.

The method may be particularly suited to determine whether or not the sphere is in compliance with predetermined specifications. To this end, the method may include the further step of comparing features of the representation with predetermined specifications to ascertain whether or not the fuel sphere complies with the specifications.

The method may include diverting a fuel sphere to a storage facility if the features of the representation of the fuel sphere do not comply with the predetermined specifications.

Further, it is of primary importance in complying with safety requirements relating to nuclear reactors, that all fuel for the reactor, whether new fuel in storage prior to loading into the reactor, fuel in use in the reactor core and ancillary fuel circulation systems, or spent fuel in storage prior to disposal, should be accounted for. It will be appreciated that a detailed accounting for all such fuel in a PB reactor requires the unique identification of each fuel sphere intended for use in the reactor.

Hence, the method may include the steps of

performing an initial identification of each fuel sphere prior to loading of the sphere into a reactor core vessel; and

performing at least one further identification of each fuel sphere.

Performing the initial identification may include

scanning each fuel sphere to provide a first representation of each fuel sphere so scanned; and

recording the first representation of each fuel sphere.

Performing the at least one further identification may include

scanning each fuel sphere exiting the reactor core vessel to provide a second representation of each fuel sphere so scanned; and

comparing the second representation with the first representations recorded in the initial identification to identify each fuel sphere exiting the reactor core vessel.

The fuel spheres may be scanned by X-rays to provide first and second digital three-dimensional images of each fuel sphere so scanned, at least the first of said digital images being recorded.

The method may include scanning the fuel sphere with X-rays by means of a CT (computerised tomography) scanner. The representation may be a digital image produced by the CT scanner. In a preferred embodiment of the invention, the image is a digital three-dimensional computer reconstruction of the fuel sphere.

Preferably, the CT scanner comprises a digital radiography X-ray machine coupled to a computerised tomography system, to provide a tomographic image.

Comparison of the representations may be by means of a computer having a pattern recognition algorithm or computer software including one, or more, such pattern recognition algorithms loaded thereon.

It will be further appreciated that in a PB reactor, fuel spheres may be loaded into the reactor core at the top of the reactor core vessel, travel under gravity through the core, and exit the reactor core at the bottom of the reactor vessel. In one embodiment of a PB reactor it is envisaged that each fuel sphere may transit the reactor up to ten times before being spent. It may be advantageous to establish empirically whether such fuel spheres travel at a uniform, or predicted rate, through the core, or whether some of the spheres travel more or less rapidly through the core and, if so, what factors may influence the pattern followed by each fuel sphere loaded into the core.

In order to monitor the passage of fuel spheres in circuit in a PB nuclear reactor, the method may include the steps of feeding fuel spheres between an outlet of the reactor core vessel and an inlet of the reactor core vessel and performing a still further identification of each fuel sphere while in circuit between the outlet of the reactor core vessel and the inlet of the reactor core vessel.

The still further identification may include

scanning each fuel sphere to provide a third representation of each fuel sphere so scanned; and

comparing the third representation with the first representations recorded in the initial scanning to identify each fuel sphere so scanned.

Performing the still further identification may include

scanning each fuel sphere by X-rays to provide a three-dimensional digital image of each fuel sphere so scanned; and

comparing the digital image with the images recorded in the initial scanning to identify the fuel spheres so scanned.

Comparing the digital images may be computerised.

The comparison of the further images may be by means of a computer having a pattern recognition algorithm or computer software including one, or more, such pattern recognition algorithm loaded thereon.

According to another aspect of the invention there is provided a nuclear plant having a reactor of the pebble bed type, the plant including a reactor core vessel having

at least one-fuel loading inlet connected to the core vessel of the reactor for loading fuel elements into the reactor core; and

a first scanning means arranged upstream of the or each fuel loading inlet to scan each fuel sphere entering the inlet to ascertain compliance with predetermined specifications before loading of the sphere into the reactor core.

The first scanning means may be operable to provide a representation of each fuel sphere scanned.

The representation may be a digital representation. The representation may be a two-dimensional image. Instead, the representation may be a three-dimensional image.

Preferably the first scanning means is a CT scanner for providing digital three-dimensional images of the fuel elements scanned.

The, or each, first CT scanner may provide a first, reference digital image of each fuel sphere scanned, thereby to identify each fuel sphere, and the first scanning means may include recording means for recording the reference digital image of the fuel sphere.

The nuclear plant may include

at least one outlet leading from the reactor core vessel of the reactor for unloading fuel elements from the reactor core; and

a second scanning means arranged to scan fuel spheres exiting the outlet.

The second scanning means may be a second CT scanner. The, or each, second CT scanner may provide a second digital three-dimensional image of each fuel sphere scanned and may include recording means for recording the second digital images of the fuel spheres.

The nuclear plant may include comparator means for comparing the second digital image of each fuel sphere with the reference images of the or each first computerised tomography scanner to identify each fuel sphere exiting the outlet.

The comparator means may include a computer having computer software including one or more pattern recognition algorithm, the software being configured to compare the second digital image with each reference digital image to establish a pattern match.

The nuclear plant may include

a fuel handling system intermediate the or each outlet and the or each inlet for cycling the fuel spheres through the core at a predetermined rate; and

at least one third scanning means arranged intermediate the outlet and the or each inlet for scanning fuel spheres in transit between the outlet and the or a respective second inlet.

The third scanning means may be a CT scanner. The, or each, third CT scanner may provide a third digital three-dimensional image of each fuel sphere scanned and may include recording means for recording the third digital image of the fuel spheres scanned.

The nuclear reactor may include a second comparator means for comparing the third digital image of each sphere with the reference images of the or each first computerised tomography scanner and to identify each fuel sphere entrained in the fuel handling system and in transit between the outlet and the or a respective inlet.

The second comparator means may include a computer having computer software including one, or more, pattern recognition algorithm, the software enabling the third digital image to be compared with each reference digital image to establish a pattern match.

Further, the nuclear reactor may include a data storage means for storing each first, second and third digital image of the fuel spheres.

According to yet another aspect of the invention there is provided a fuel element for use in a pebble bed reactor which element is generally spherical and includes

a plurality of fuel particles; and

at least one identification element.

The fuel element may include a plurality of dummy-coated particles which serve as identification elements. The dummy coated particles may be manufactured from any suitable material to any suitable size compatible with the fuel element spheres and the reactor environment, i.e. high thermal stability.

The density of the dummy coated particle kernels will be different to the fuel element matrix material to differentiate between the two and facilitate easy identification of the dummy coated particles with the matrix. In one embodiment of the invention the particles may be manufactured from burnable poisons.

The number and dispersion of dummy coated particles with the fuel spheres shall be sufficient to uniquely identify the fuel sphere within the entire plant lifetime supply of fuel spheres.

This the Inventor believes will facilitate identification of the sphere as set out above.

The invention is now described, by way of example, with reference to the accompanying diagrammatic drawings.

In the drawings,

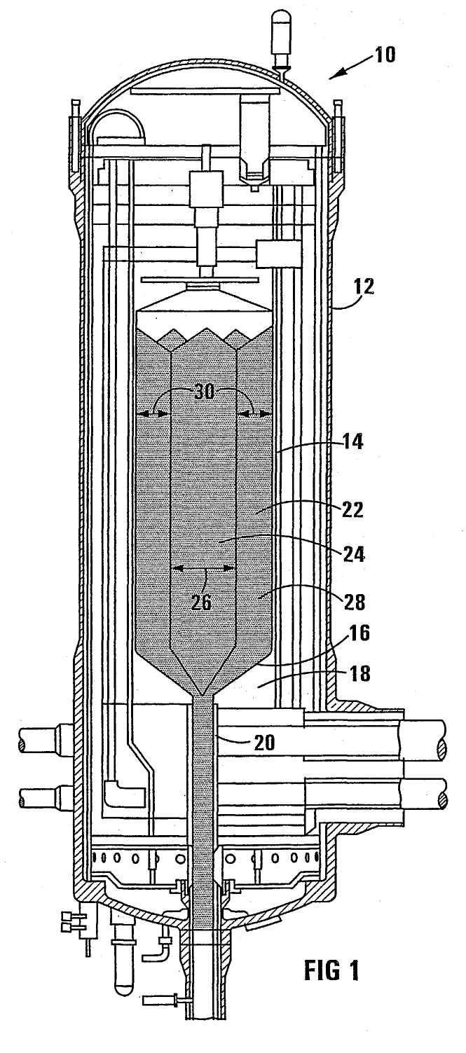

FIG. 1 shows a sectional side view of a nuclear reactor pressure vessel forming part of a nuclear plant in accordance with the invention; and

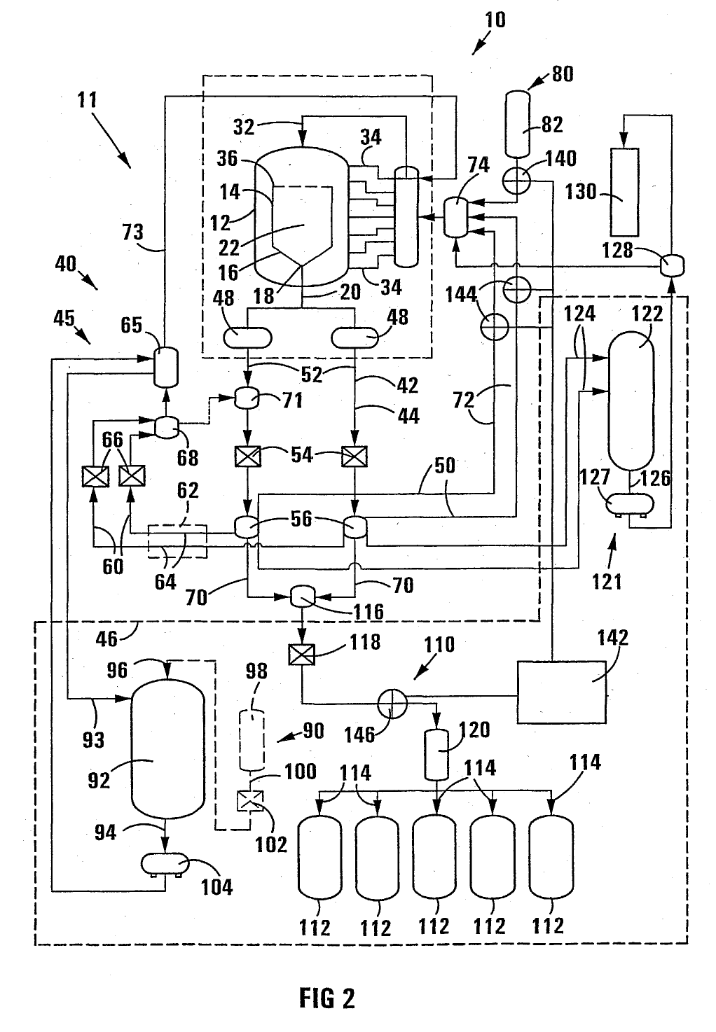

FIG. 2 shows a schematic view of a system layout of part of a nuclear plant in accordance with the invention.

In the drawings, reference numeral 10 generally indicates a nuclear reactor of the pebble bed type forming part of a nuclear plant, in accordance with the invention.

The reactor 10 is a high temperature gas cooled reactor, the coolant gas being helium and the reactor has a generally cylindrical pressure vessel 12. Further, the reactor has a generally cylindrical containment or core vessel 14 within the pressure vessel 12 and coaxial therewith. The core vessel 14 has a funnel-shaped lower end portion 16 which tapers inwardly towards an operatively lower end 18. A single outlet 20 is defined at the lower end 18 of the vessel 14, projecting outwardly therefrom and coaxially therewith.

A reactor core 22 is contained within the reactor core vessel 14. The reactor core 22 comprises a plurality of spherical graphite moderator elements 24 located in a central generally cylindrical region 26 defined in the core 22 and a plurality of spherical fuel elements 28 located in an annular region 30 defined in the core 22 and surrounding the central region 26.

The core vessel 14 has a single first inlet 32 (not shown in FIG. 1) which is configured to load graphite spheres 24 into the central region 26 of the core 22 via the first inlet 32. Further, the core vessel 14 has seven second inlets 34 (not shown in FIG. 1) which are configured to permit fuel spheres 28 to be loaded into the annular region 30 of the core 22 via the said second inlets 34. The first and second inlets (32, 34) are located in an operatively upper end region 36 of the core vessel 14. The second inlets 34 are arranged in an angularly spaced relation about a longitudinal axis of the core vessel 14 and symmetrically spaced with respect to the annular region 30. It will be appreciated that there may be more than one graphite sphere inlet 32 and more, or fewer, than seven fuel sphere inlets 34.

The nuclear plant, part of which is generally indicated by reference numeral 11 in FIG. 2, has a fuel handling system 40 intermediate the outlet 20 and each of the first and second inlets (32, 34), for cycling the graphite spheres 24 and fuel spheres 28 through their respective regions 26 and 30, respectively, of the core 22 at a predetermined rate. The fuel handling system 40 defines a flow path 42 intermediate the outlet 20 and each of the inlets (32, 34). The flow path 42 includes an arrangement of conduit lines 44. Motive force for the moderator 24 and fuel spheres 28 about the handling system 40 is provided, in part, by helium coolant gas from the reactor pressure vessel 12 and the moderator 24 and fuel spheres 28 are entrained in a gas flow stream defined by the flow path 42. The fuel handling system 40 has a high pressure region 45 and a low pressure region 46, the low pressure region 46 being indicated by the dashed region labelled 46 in the drawings. The high pressure region 45 comprises those components of the fuel handling system 40 outside the low pressure region 46. In the high pressure region 45 of the fuel handling system 40, the flow path 42 of the handling system 40 is in fluid communication with the reactor core 22 and the gas flow stream is provided by means of reactor coolant gas, being helium, at the pressure of the coolant gas within the reactor pressure vessel 12. The gas flow stream of the low pressure region 46 of the fuel handling system 40 is provided by helium gas at relatively low pressure and pressure locks (not shown) are provided in the handling system conduits 44 at boundaries between the high pressure region 45 and the low pressure region 46 to bridge the said boundaries.

The fuel handling system has a fuel sphere flow path 50 which is operative during normal operation of the reactor 10 and a moderator sphere flow path 60 which is also operative during normal operation of the reactor 10.

Under normal operating conditions, fuel spheres 28 and graphite spheres 24 move continually under gravity through the core 22 of the reactor 10 from the upper region 36 of the core vessel 14 to the lower portion 16 of the core vessel 14. At the lower end 18 of the core vessel 14 they exit the vessel 14 via the outlet 20. A pair of first sphere handling machines 48 is connected to the outlet 20 and the machines 48 are operable to feed discharged spheres (24, 28) one at a time into a pair of flow lines 52. On each of the flow lines 52 a first radiation and burn-up sensor 54 is mounted. The sensors 54 are operable to sense and measure nuclear radiation emitted by passing moderator spheres 24 or fuel spheres 28 in the respective flow lines 52 and to transmit a signal containing information representative of the measurements made. Each of the sensors 54 is operatively coupled to a first diverter valve 56 via a computer controller (not shown). The controller is programmed to control the diverter valve 56 to divert incoming spheres (24, 28) to one of three ports, depending on the status and condition of the respective sphere (24, 28), information representative of which is transmitted by the radiation and burn-up sensor 54 to the controller. Graphite moderator spheres 24 are diverted into the moderator sphere flow path 60; fuel spheres 28 are diverted into the fuel sphere flow path 50; and damaged or spent fuel spheres 28 are diverted into a third fuel storage flow path 70.

Graphite moderator spheres 24 entering the moderator sphere flow path 60 are routed via a temporary storage and inspection region 62. In the temporary storage and inspection region 62, graphite moderator spheres 24 are delayed for a period of time, which may be of the order of five days, in order to facilitate the identification misdirected fuel spheres 24 which may inadvertently have entered the moderator sphere flow path 60. Also, in the inspection region 62, graphite spheres are inspected for physical defects. Conduits 64 of the flow path 60 in the inspection region 62 are helical in shape to facilitate X-ray inspection of each passing graphite moderator sphere from all sides. From the inspection region 62, moderator spheres 24 and misdirected fuel spheres 28 are fed past third radiation sensors 66 which are operatively coupled to a third diverter valve 68. Both the third diverter valve 68 and the third radiation sensors 66 are connected to the controller and the diverter valve 68 is operable to divert misdirected fuel spheres 28 back into a flow line 52 intermediate the outlet 20 and one of the first radiation sensors 54 via a three way sphere control valve 71. Graphite moderator spheres 24 are diverted via a control valve 65 and an inlet loop 73 into the first inlet 32 of the core vessel 12.

Fuel spheres 28 which are neither spent nor damaged are diverted via the first diverter valves 56 into the fuel sphere flow path 50 and, via a pair of second inlet lines 72 into the second inlets 34 of the core vessel 12 via a sphere control device 74 which is coupled to the controller and operable to distribute fuel spheres 28 in a predetermined sequence to the seven second inlets 34 of the fuel handling system 40.

The fuel handling system 40 includes a new fuel storage system 80 for storing new fuel spheres 28 and for feeding new fuel spheres 28 at predetermined intervals into the reactor core 22 via the second inlets 34. New fuel spheres 28 are introduced into the handling system 40 from a new fuel storage vessel 82 and pressure lock when the fuel spheres 28 are introduced to the inlets 34 via the sphere control device 74.

The fuel handling system 40 further includes a moderator sphere storage system 90 for storing graphite moderator spheres 24. The moderator sphere storage system 90 includes a moderator sphere storage tank 92 having an inlet 93 and an outlet 94, the inlet 93 being operatively coupled to the control valve 65 of the moderator flow path 60 and the outlet 94 being coupled to the same control valve 65 of the moderator flow path 60. Thus, by operation of the third control valve 65, under control of the controller, graphite moderator spheres 24 discharged from the reactor core 22 may be diverted to the graphite sphere storage tank 92 for storing, rather than being recycled back into the reactor core 22, thereby enabling the complete discharge of moderator spheres 24 from the reactor core 22 for maintenance purposes. As required, the reactor core 22 may be recharged with moderator spheres 24 from the moderator sphere storage tank 92 via the control valve 65 and the first inlet 32. The moderator sphere storage tank 92 further has a second inlet 96 coupled to a sphere and helium lock 98 via a feed line 100 through which fresh moderator spheres 24 may be introduced to the system 40. A fourth radiation sensor 102 is located in the feed line 100 intermediate the lock 98 and the moderator sphere storage tank 92 for sensing inadvertent introduction of fuel spheres 28 into the moderator sphere storage tank 92. Moderator spheres 24 are loaded from the storage tank 92 into the moderator sphere flow path 60 by means of a third sphere handling machine 104. The lock 98 and fourth radiation sensor 102 may be a portable unit and are shown in dotted lines in the drawings.

The fuel handling system 40 further includes a spent fuel storage system 110. The spent fuel storage system 110 includes thirteen spent fuel storage tanks 112, of which five are shown in FIG. 2 of the drawings, for permanent storage on site of spent and damaged fuel spheres 28. Preferably, the capacity of the spent fuel storage tanks 112 is calculated to accommodate spent and damaged fuel spheres 28 over the anticipated operational life of the nuclear reactor 10. Inlets 114 to the fuel storage tanks 112 are operatively coupled to the first diverter valves 56 via a fifth diverter valve 116. A fifth radiation sensor 118 is located intermediate the diverter valve 116 and a thirteen port diverter valve 120 which is connected to the spent fuel storage tanks 112, and is operable to divert spent fuel spheres 28 to a predetermined storage tank 112, and to detect any moderator spheres 24 which may inadvertently have been diverted into the spent fuel storage system 110.

The fuel handling system 40 further includes a temporary fuel storage system 121. The temporary fuel storage system 121 includes a temporary fuel storage tank 122 for storing in-use fuel spheres 28 on a temporary basis. The temporary fuel storage tank 122 also includes inlets 124 operatively coupled to the first diverter valves 56 and an outlet 126 operatively coupled to the second inlets 34 of the reactor core vessel 14 via a fifth diverter valve 128 and via the control device 74. As with the graphite spheres 24, during maintenance of the reactor core 22 the fuel spheres 28 may be discharged from the reactor core 22 and, rather than being circulated back to the reactor core 22, may be temporarily stored in the temporary fuel storage tank 122 whilst maintenance takes place. On completion of maintenance, the fuel spheres 28 may be recharged into the reactor core 22 via the second inlets 34 of the core containment vessel 14 by means of a fourth sphere handling machine 127. Provision is made for a last core fuel cask 130, which is connected to the fifth diverter valve 128 and into which the reactor core 22 may be dumped at the end of the operating life of the reactor 10.

It will be appreciated that in a reactor of the pebble bed type 10 operating according to a multi-pass fuelling scheme, fuel spheres 28 are moved through the core 22 more than once, for example up to ten times, before being exhausted (burnt-up) to the extent that they are no longer utile. The nuclear plant 11 in accordance with the invention as described herein includes a fuel handling system 40 which is operable to keep fuel 28 and graphite moderator spheres 24 separate after exiting from the reactor core 22. The fuel 28 and graphite moderator spheres 24 are fed into the reactor core 22 above the pebble bed by supply tubes (32, 34) arranged in a specific order to ensure the two zone core loading with moderator spheres 24 in the central region 26 and fuel spheres 28 in the annular region 30 surrounding the graphite. The main parts of the fuel handling system 40 are preferably located in shielded, individual compartments below the reactor pressure vessel 12. The spent fuel storage system 110, which is designed as a lifetime spent fuel store and post operations intermediate store is located in a lower part of the reactor building. The storage system 40 enables the loading of the core containment vessel 14 with moderator spheres 24 and the loading of new fuel spheres 28 into the core 22. Further, the handling and storage system 40 provides for the removing of erroneously discharged fuel spheres 28 from the moderator sphere flow path 60 and the prevention of erroneously discharged moderator spheres 24 initiating the loading of new fuel spheres 28, via a radiation sensor 118 fitted to the delivery line to the spent fuel storage tanks 112. A detected moderator sphere 24 going the wrong way may not initiate the loading of the new fuel sphere 28. Still further, the fuel handling and storage system 40 provides for the removal of fuel 28 and moderator spheres 24 from the discharge outlet 20, the separation of damaged spheres (24, 28), the separation of fuel 28, absorber and graphite moderator spheres 24, the re-circulating of moderator spheres 24 and the re-circulation of partially used fuel spheres 28 through the core 22. Burn-up of partially used fuel spheres 28 is measured and spent fuel spheres 28 are discharged into the spent fuel storage system 110. It will be appreciated that in a PB reactor it is anticipated that absorber spheres may be included in the core 22. While the treatment of absorber spheres from the core 22 is not specifically described herein, it is anticipated that the sphere handling system 40 may be readily adapted to separate, store and circulate such absorber spheres in a manner analogous to that described herein for moderator 24 and fuel spheres 28.

Under normal operation, the moderator 24 and fuel spheres 28 are separated on a continuous basis. The burn-up sensors 54 perform two functions, namely: to distinguish fuel spheres 28, moderator spheres 24 and absorber spheres from one another; and to measure burn-up of fuel spheres 28. A diverter valve 56 receiving information from the burn-up sensor 54, will send the measured sphere (24, 28) in one of three directions: either along the spent fuel storage flow path 70; along the fuel sphere flow path 50; or along the moderator sphere flow path.

Fuel spheres 28 are forwarded to the reactor 10 pneumatically by primary coolant. Two types of forwarding systems are used. The first forwarding system uses the extracted gas from the main gas stream. The second forwarding system is a blower system. The first forwarding system by-passes the blower (not shown) so that the blower can be maintained. In exceptional cases, such as an initial loading of the core 22 or re-filling of the core 22 with moderator spheres 24 after emptying for inspection or repair, pneumatic forwarding is performed in air under pressure with the reactor pressure vessel 12 vented.

The moderator spheres 24 are sent to an inspection region 62 (buffer line) during normal operations, the buffer line 62 holding a stock of moderator spheres 24. The spheres 24 in the buffer line 62 are monitored for radiation. This allows time for any erroneously discharged fuel spheres 28 to be detected and returned to the main fuel sphere flow path 50.

The handling and storage system 40 provides for the de-fuelling and re-fuelling of the core 22 by transfer of the core inventory from the reactor 10 into separate moderator and fuel storage tanks (92, 122) located in an area adjacent to the reactor 10 during maintenance intervention requiring the venting of the main power system to atmosphere. Correspondingly, the system 40 provides for the re-loading of the core 22 from these tanks (92, 122) during re-fuelling of the core 22.

De-fuelling of the core 22 will only take place if it is necessary to open the main power system (MPS) to the atmosphere for maintenance. To prevent fuel corrosion, it is necessary to store fuel spheres 28 under helium pressure in the fuel storage tank 122 adjacent to the reactor 10. The reactor pressure is reduced and the low pressure is connected to the high pressure system by the opening of the pressure valves. Fuel 28 and moderator spheres 24 are separated by using radiation sensors 54. The moderator spheres 24 contained in the core 22 together with the moderator spheres 24 which have been retrieved from the storage tank 92 will be re-circulated to the core 22. The loading of the core 22 with moderator spheres 24 is to avoid horizontal movement of the fuel spheres 28 to the central region 26 of the core 22 and to maintain adequate core volume. The fuel spheres 28 are delivered via the inlets 124 to the water cooled and critically safe fuel storage tank 122. During the de-fuelling mode, the spent fuel storage system 110 is out of service. Further, no new fuel loading takes place and no new moderator sphere loading or replenishment takes place.

After maintenance to the reactor power system, re-fuelling will commence. The required operational pressure and temperature of the helium will be maintained and the core 22 filled with graphite spheres 24. The fuel 28 and graphite moderator spheres 24 are loaded on top of the graphite sphere bed in the core 22. The graphite sphere bed is removed at the same rate as the fuel 28 and moderator sphere 24 loading on the top of the graphite sphere bed. Once the two zone core is established, the fuel storage tank 122 will be empty and the storage tank 92 will be approximately three quarters full and a graphite buffer storage tank (not shown) will be full. At this point, start up of the reactor 10 can commence. The re-fuelling equipment is taken out of service and isolated from the high pressure components by closing the isolation valves between the low 46 and high pressure circuits 46.

In the system as described, fuel 28 and graphite spheres 24 are conveyed in conduit lines 44, which preferably are horizontally or vertically orientated, partly by gravity but predominantly pneumatically by using mainly the primary coolant gas at primary systems pressure. Monitoring of fuel sphere 28 movement is performed with the aid of measurement and counting instruments (54, 66, 118), whose signals provide input to the control system which actuates the operating components in valves (56, 68, 71) of the system 40.

In order to provide for ascertaining of the compliance of the fuel spheres 28 with prescribed specifications and the monitoring of the fuel spheres 28 within the reactor system, a first CT scanner 140 comprises a digital X-ray machine coupled to a computerised tomography system, including a computer controlled turntable (not shown) for rotation of the fuel sphere 58 being scanned, and produces a digital three-dimensional computer reconstructed image of each fuel sphere 28 scanned. It will be appreciated that the first CT scanner 140 may be located at any suitable position upstream of the second inlets 34 and may even be located in a separate loading area where fuel spheres 28 are loaded into new fuel vessels 80 prior to connection to the reactor system, and the invention is intended to extend to the use of a CT or other scanner in such a manner. The first CT scanner 140 is connected to a computer 142 having a data base and having computer software loaded thereon, and the digital images of the fuel spheres 28 provided by the first CT scanner 140 are stored in the data base. The computer 142 is programmed automatically to check features of the fuel spheres 28 scanned and to compare the said features with specified data for compliance with specifications. For example, the shape of the fuel sphere 28, the number and spacing of the fissile elements within the sphere 28, and the like, may be compared with preselected data for compliance with specifications.

A second CT scanner 146 is located intermediate the fifth radiation sensor 118 and the diverter valve 120. The second CT scanner 146 is similar to the first CT scanner 140 and also comprises a digital X-ray machine coupled to a computerised tomography system and produces a digital three-dimensional computer reconstructed image of each fuel sphere 28 scanned. Further, the second CT scanner 146 is connected to the computer 142 and the digital images of the fuel spheres 28 provided by the second CT scanner 146 are stored in the data base. The computer 142 has pattern recognition software to enable the digital images produced by the second CT scanner 146 to be matched with those of the first CT scanner 140. In this way, each new fuel sphere 28 introduced to the reactor 10 is uniquely identified and its identity recorded and each spent fuel sphere 28 delivered to the spent fuel storage system 110 is identified, thereby permitting the fuel inventory of the reactor 10 to be established, as well as the inventory of new and spent fuel spheres 28. Again, it will be appreciated that the second CT scanner 146 may be located in any suitable position upstream of the spent fuel storage tanks 112.

A pair of third CT scanners 144 are located on the inlet flow lines 72. The third CT scanners 144 are again similar to the second CT scanner 146 and are connected to the computer 142 and the digital images of the fuel spheres 28 provided by the third CT scanners 144 are stored in the data base. Once again, the pattern recognition software of the computer 142 enables the digital images produced by the third CT scanners 144 to be matched with those of the first CT scanner 140. In this way, each new fuel sphere 28 exiting the outlet 20 of the core vessel 14 and entrained in the fuel sphere flow path 50 may be identified, thereby permitting the transit times of the fuel spheres 58 through the core 22 to be established, and data relating to the number of transits of each fuel sphere 58 through he core 22 to be obtained. Again, it will be appreciated that the third CT scanners 144 may be located in any suitable position intermediate the outlet 22 and the second inlets 34 of the vessel 14. Further, the number of first, second and third CT scanners 140, 146 and 144 may be varied according to the design of the reactor system and according to time constraints related to the time required for completion of the scanning process on line. To facilitate identification of the fuel spheres they may be seeded with a sufficient number of sufficiently distinctive dummy-coated particles. The Inventor believes that this will minimise the time required to produce a unique identification of each sphere. It will be further appreciated, that in a nuclear reactor 10 of the design described, CT scanners may be positioned at other selected locations such as upstream of the inlets 124 of the temporary fuel storage tank 122 or downstream of the outlet 126 thereof, thereby providing enhanced inventory control.

By means of the invention, there is provided a method of unique identification of each fuel sphere 58 used in a PB nuclear reactor 10. The unique identification provides for accurate inventory control, to comply with international safety requirements. A further advantage is that valuable data may be obtained in relation to the performance of the fuel handling system 40 of the reactor 10 and of the reactor core 22.

1. A method of handling fuel spheres suitable for use in a pebble bed reactor which includes the step of scanning each fuel sphere at least once to provide a representation thereof.

2. A method as claimed in claim 1, which includes recording the representation of the fuel sphere.

3. A method as claimed in claim 2, in which the representation is a two-dimensional image.

4. A method as claimed in claim 3, in which the two-dimensional image is a sectional slice through the fuel sphere.

5. A method as claimed in claim 2, in which the representation is a three-dimensional image.

6. A method as claimed in any one of the preceding claims, which includes scanning the fuel sphere with X-rays by means of a computerised tomography scanner and producing a digital image of the fuel sphere.

7. A method as claimed in any one of the preceding claims, which includes the further step of comparing features of the representation with predetermined specifications to ascertain whether or not the fuel sphere complies with the specifications.

8. A method as claimed in claim 7, which includes diverting a fuel sphere to a storage facility if the features of the representation of the fuel sphere do not comply with the predetermined specifications.

9. A method as claimed in any one of the preceding claims, which includes the steps of
performing an initial identification of each fuel sphere prior to loading of the sphere into a reactor core vessel; and
performing at least one further identification of each fuel sphere.

10. A method as claimed in claim 9, in which performing the initial identification includes
scanning each fuel sphere to provide a first representation of each fuel sphere so scanned; and
recording the first representation of each fuel sphere.

11. A method as claimed in claim 10, in which performing the at least one further identification includes
scanning each fuel sphere exiting the reactor core vessel to provide a second representation of each fuel sphere so scanned; and
comparing the second representation with the first representations recorded in the initial identification to identify each fuel sphere exiting the reactor core.

12. A method as claimed in claim 11, in which the fuel spheres are scanned by X-rays to provide first and second digital three-dimensional images of each fuel sphere so scanned, at least the first of said digital images being recorded.

13. A method as claimed in claim 12, in which comparison of the representations is by means of a computer having a pattern recognition algorithm or computer software including one, or more, such pattern recognition algorithms loaded thereon.

14. A method as claimed in any one of claims 11 to 13, inclusive which includes the steps of feeding fuel spheres between an outlet of the reactor core vessel and an inlet of the reactor core vessel and performing a still further identification of each fuel sphere while in circuit between the outlet of the reactor core vessel and the inlet of the reactor core vessel.

15. A method as claimed in claim 14, in which the still further identification includes
scanning each fuel sphere to provide a third representation of each fuel sphere so scanned; and
comparing the third representation with the first representations recorded in the initial scanning to identify each fuel sphere so scanned.

16. A method as claimed in claim 15, in which performing the still further identification comprises
scanning each fuel sphere by X-rays to provide a three-dimensional digital image of each fuel sphere so scanned; and
comparing the digital image with the images recorded in the initial scanning to identify the fuel spheres so scanned.

17. A method as claimed in claim 16, in which comparing the digital images is computerised.

18. A nuclear plant having a reactor of the pebble bed type, the plant including a reactor core vessel having
at least one fuel loading inlet connected to the core vessel of the reactor for loading fuel elements into the reactor core; and
a first scanning means arranged upstream of the or each fuel loading inlet to scan each fuel sphere entering the inlet to ascertain compliance with predetermined specifications before loading of the sphere into the reactor core.

19. A nuclear plant as claimed in claim 18, in which the first scanning means is operable to provide a representation of each fuel sphere scanned.

20. A nuclear plant as claimed in claim 19, in which the representation is a digital representation.

21. A nuclear plant as claimed in claim 19 or claim 20, in which the representation is a two-dimensional image.

22. A nuclear plant as claimed in claim 19 or claim 20, in which the representation is a three-dimensional image.

23. A nuclear plant as claimed in claim 22, in which the first scanning means is a computerised tomography scanner for providing digital three-dimensional images of the fuel elements scanned.

24. A nuclear plant as claimed in claim 23, in which the computerised tomography scanner provides a first, reference digital image of each fuel sphere scanned, thereby to identify each fuel sphere, the first scanning means including recording means for recording the reference digital image of the fuel sphere.

25. A nuclear plant as claimed in claim 24, which includes
at least one outlet leading from the core vessel of the reactor for unloading fuel elements from the reactor core; and
a second scanning means arranged to scan fuel spheres exiting the outlet.

26. A nuclear plant as claimed in claim 25, in which the second scanning means includes a second computerised tomography scanner configured to provide a second digital three-dimensional image of each fuel sphere scanned and including recording means for recording the second digital images of the fuel spheres.

27. A nuclear plant as claimed in claim 26, which includes comparator means for comparing the second digital image of each fuel sphere with the reference images of the or each first computerised tomography scanner to identify each fuel sphere exiting the outlet.

28. A nuclear plant as claimed in claim 27, in which the comparator means includes a computer having computer software including one or more pattern recognition algorithm, the software being configured to compare the second digital image with each reference digital image to establish a pattern match.

29. A nuclear plant as claimed in any one of claims 23 to 28, inclusive, which includes
a fuel handling system intermediate the or each outlet and the or each inlet for cycling the fuel spheres through the core at a predetermined rate; and
at least one third scanning means arranged intermediate the outlet and the or each inlet for scanning fuel spheres in transit between the outlet and the or a respective second inlet.

30. A nuclear plant as claimed in claim 29, in which the third scanning means is a computerised tomography scanner configured to provide a third digital three-dimensional image of each fuel sphere scanned and including recording means for recording the third digital image of the fuel spheres scanned.

31. A nuclear plant as claimed in claim 30, which includes a second comparator means for comparing the third digital image of each sphere with the reference images of the or each first computerised tomography scanner and to identify each fuel sphere entrained in the fuel handling system and in transit between the outlet and the or a respective second inlet.

32. A nuclear plant as claimed in claim 31, in which the second comparator means includes a computer having computer software including one or more pattern recognition algorithm, the software enabling the third digital image to be compared with each reference digital image to establish a pattern match.

33. A nuclear plant as claimed in any one of claims 30 to 32, inclusive, which includes a data storage means for storing each first, second and third digital image of the fuel spheres.

34. A fuel element for use in a pebble bed reactor which is generally spherical and includes
a plurality of fuel particles; and
at least one identification element.

35. A fuel element as claimed in claim 34, which includes a plurality of dummy-coated particles which serve as identification elements.

36. A method of handling a fuel sphere as claimed in claim 1, substantially as described and illustrated herein.

37. A nuclear plant as claimed in claim 18, substantially as described an illustrated herein.

38. A fuel element as claimed in claim 34, substantially as described and illustrated herein.

39. A new method, plant or fuel element, substantially as described herein.
